(19) United States
(12) Patent Application Publication
(10) Pub. No.: US 2014/0065418 A1
(43) Pub. Date: Mar. 6, 2014

(54) INSULATED WIRE AND COIL USING THE SAME

(71) Applicant: Hitachi Metals, Ltd., Tokyo (JP)

(72) Inventors: Hideyuki KIKUCHI, Hitachi (JP); Hidehito HANAWA, Hitachi (JP); Shuta NABESHIMA, Hitachi (JP); Yuki HONDA, Hitachi (JP); Masashi ARAI, Hitachi (JP)

(73) Assignee: Hitachi Metals, Ltd., Tokyo (JP)

(21) Appl. No.: 14/014,838

(22) Filed: Aug. 30, 2013

(30) Foreign Application Priority Data
Sep. 4, 2012 (JP) 2012-193715

(51) Int. Cl. H01B 7/02

(52) U.S. Cl. CPC H01B 7/0225; H01B 7/02; H01B 7/0216
USPC 428/370; 428/379; 428/383

(57) ABSTRACT

An insulated wire including conductor, and a first resin layer formed on an outer periphery of the conductor, wherein the first resin layer includes an insulating resin including inorganic fine particles and an unreacted organic metal. An insulated wire including a conductor, a second resin layer formed on an outer periphery of the conductor and including an insulating resin that contains inorganic fine particles, and a third resin layer formed under the second resin layer and including an unreacted organic metal.

The present application is based on Japanese patent application No. 2012-193715 filed on Sep. 4, 2012, the entire contents of which are incorporated herein by reference.

### BACKGROUND OF THE INVENTION

1. Field of the Invention

The invention relates to an insulated wire as well as a coil using the insulated wire. In more detail, the invention relates to an insulated wire used in electric equipment such as a motor as well as a coil using the insulated wire.

2. Description of the Related Art

In electric equipments with high applicable voltage, e.g., in a motor, etc., used at high voltage, application of high voltage to an insulated wire as a component of the electric equipment causes an electric field concentration in minute gaps/voids, if present, between adjacent insulated wires or in an insulation layer (an insulating film) and partial discharge is thus likely to occur. The problem is that deterioration of the insulation layer due to such partial discharge causes insulation breakdown in an early stage and this shortens the lifetime of the electric equipment. Therefore, in an insulated wire constituting a coil of a motor, etc., used at high voltage, an insulation layer covering a conductor is required to have an improved partial discharge resistance to extend the lifetime, in addition to being excellent in insulation properties, adhesion to a conductor, heat resistance and mechanical strength, etc.

In recent years, inverter surge (steep overvoltage) and resultant insulation breakdown often occur in systems in which a motor, etc., is driven by an inverter used for energy saving and variable speed control, and it has been found that overvoltage due to inverter surge causes partial discharge, leading to insulation breakdown.

As a method of extending the lifetime, an inorganic material formed of a metal oxide or a silicon oxide is filled in an insulation layer to suppress erosion of the film due to partial discharge. Meanwhile, a partial-discharge-resistant enamel wire is also required to have flexibility and mechanical characteristics to withstand a bending process during coil formation. Accordingly, the following methods have been proposed: a method in which an insulation layer for imparting partial discharge resistance is formed using an organic-inorganic nanocomposite to improve flexibility; and a method using a structure in which an insulation layer for imparting partial discharge resistance is sandwiched by general-purpose enamel films to compensate for brittleness of the insulation layer (see, e.g., Japanese patent No. 3496636 and U.S. Pat. No. 5,654,095).

### SUMMARY OF THE INVENTION

In the insulated wire filled with an inorganic material, etc., when the insulation layer is eroded and lost due to partial discharge, the inorganic material filled in the insulation layer becomes deposited on a surface of the eroded portion due to the absence of the insulation layer. The erosion of the remaining insulation layer due to partial discharge is suppressed by this inorganic material deposited on the surface of the insulation layer and partial discharge resistance of the insulation layer is thereby improved. In other words, in this insulated wire, the inorganic material which is deposited and firmly fixed onto the insulation layer exerts a suppressive effect on erosion of the surface of the insulation layer caused by partial discharge.

However, in a motor or a transformer, etc., in which electromagnetic vibration or mechanical vibration, etc., is applied during operation, the deposited inorganic material comes off from the surface of the insulation layer due to such vibrations and the suppressive effect on the erosion of the insulation layer may not be sufficiently obtained. Therefore, only filling an inorganic material, etc., into the insulation layer has a limit to suppress erosion of the insulation layer caused by partial discharge.

It is an object of the invention to provide an insulated wire with voltage endurance remarkably increased by improving partial discharge resistance, as well as a coil using the insulated wire.

As a result of intense study to achieve the above-mentioned object, the inventors found that if in an insulated wire used for a coil, inorganic fine particles contained in an insulation layer provided on an outer periphery of a conductor are deposited on a surface of the insulation layer due to partial discharge and then form an inorganic layer which does not come off from the insulation layer and is held on the surface of the insulation layer even under electromagnetic vibration or mechanical vibration, etc., during operation (during use) of a coil, erosion of the insulation layer due to partial discharge can be suppressed by the inorganic layer, and thereby the invention was completed.

(1) According to one embodiment of the invention, an insulated wire comprises:

a conductor; and

a first resin layer formed on an outer periphery of the conductor,

wherein the first resin layer comprises an insulating resin comprising inorganic fine particles and an unreacted organic metal.

(2) According to another embodiment of the invention, an insulated wire comprises:

a conductor;

a second resin layer formed on an outer periphery of the conductor and comprising an insulating resin that contains inorganic fine particles; and

a third resin layer formed under the second resin layer and comprising an unreacted organic metal.

In the above embodiment (1) or (2) of the invention, the following modifications and changes can be made.

(i) The organic metal comprises one of metal alkoxide, metal chelate and metal acylate.

(ii) The organic metal is included in a state of being encapsulated in a covering material constituting a capsule.

(iii) The inorganic fine particle comprises organo-silica sol.

(iv) The insulated wire further comprises an inorganic layer formed on the first or third resin layer by reaction between the organic metal and the inorganic fine particles, the organic metal and the inorganic fine particles being deposited on a surface of the first or third resin layer due to partial discharge.

(v) The insulated wire of the embodiment (1) further comprises a fourth resin layer under the first resin layer or a fifth resin layer on the first resin layer.

(vi) The insulated wire of the embodiment (2) further comprises a fourth resin layer under the second resin layer or a fifth resin layer on the third resin layer.

(3) According to another embodiment of the invention, a coil comprises the insulated wire of the embodiment (1) or (2).

### Effects of the Invention

According to one embodiment of the invention, an insulated wire can be provided that has voltage endurance remarkably increased by improving partial discharge resistance, as well as a coil using the insulated wire.

### BRIEF DESCRIPTION OF THE DRAWINGS

Next, the present invention will be explained in more detail in conjunction with appended drawings, wherein:

FIG. 1A is a cross sectional view showing an insulated wire in a first embodiment of the invention;

FIG. 1B is a cross sectional view showing an insulated wire in a second embodiment of the invention;

FIG. 2A is a cross sectional view showing an insulated wire in a first modification of the first embodiment of the invention;

FIG. 2B is a cross sectional view showing an insulated wire in a first modification of the second embodiment of the invention;

FIG. 3A is a cross sectional view showing an insulated wire in a second modification of the first embodiment of the invention; and

FIG. 3B is a cross sectional view showing an insulated wire in a second modification of the second embodiment of the invention.

### DETAILED DESCRIPTION OF THE PREFERRED EMBODIMENTS

### Summary of Embodiments

An insulated wire of the embodiments is provided with a conductor and a first resin layer formed on an outer periphery of the conductor and made of an insulating resin containing inorganic fine particles and an unreacted organic metal, or is provided with a conductor, a second resin layer formed on an outer periphery of the conductor and made of an insulating resin containing inorganic fine particles and a third resin layer formed under the second resin layer and containing an unreacted organic metal.

### Embodiments

The embodiments of an insulated wire and a coil using the same according to the invention will be described in detail below with reference to the drawings.

Insulated Wire

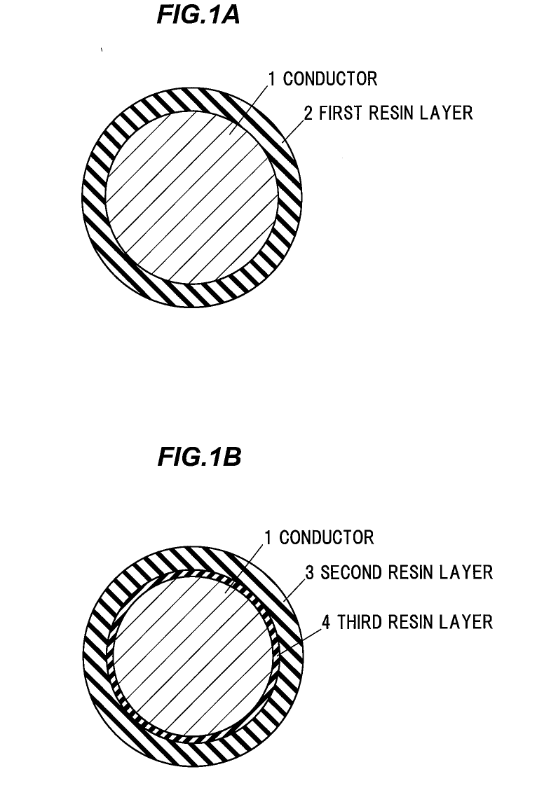

FIG. 1A is a cross sectional view showing an insulated wire in the first embodiment of the invention. As shown in FIG. 1A, the insulated wire of the first embodiment is composed of a conductor 1 and a first resin layer 2 formed on an outer periphery of the conductor 1 and made of an insulating resin containing inorganic fine particles and an unreacted organic metal.

Here, “unreacted” means a state in which an organic metal is present in a resin layer without reacting with a resin or inorganic fine particles and can be reacted with the inorganic fine particles when, e.g., being exposed.

Meanwhile, FIG. 1B is a cross sectional view showing an insulated wire in the second embodiment of the invention. As shown in FIG. 1B, the insulated wire of the second embodiment may be provided with the conductor 1, a second resin layer 3 formed on an outer periphery of the conductor 1 and made of an insulating resin containing inorganic fine particles, and a third resin layer 4 formed under the second resin layer 3 and containing an unreacted organic metal. In the second embodiment, another resin layer may be interposed between the second resin layer 3 and the third resin layer 4. Although the following is the description for the first embodiment, the same applies to the second embodiment.

In the first embodiment, it is preferable that an inorganic layer (not shown) formed on a surface of the first resin layer 2 be further provided. The inorganic layer is formed by reaction between the discharged organic metal and the inorganic fine particles which are deposited on the surface of the first resin layer 2 due to partial discharge.

In other words, in the first embodiment, since the inorganic layer (e.g., a SiO₂ layer) is formed on the surface of the first resin layer 2 by reaction between the inorganic fine particles and the organic metal which are exposed on the surface of the first resin layer 2, it is possible to effectively prevent falling of the inorganic fine particles from the surface of the first resin layer 2 and erosion of the first resin layer 2 due to partial discharge. As a result, it is possible to improve lifetime (resistance) against partial discharge.

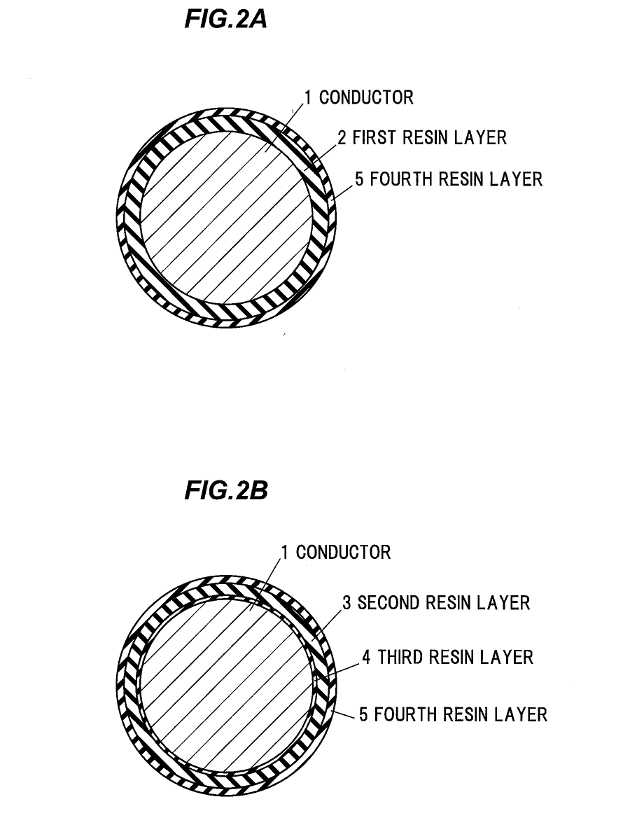

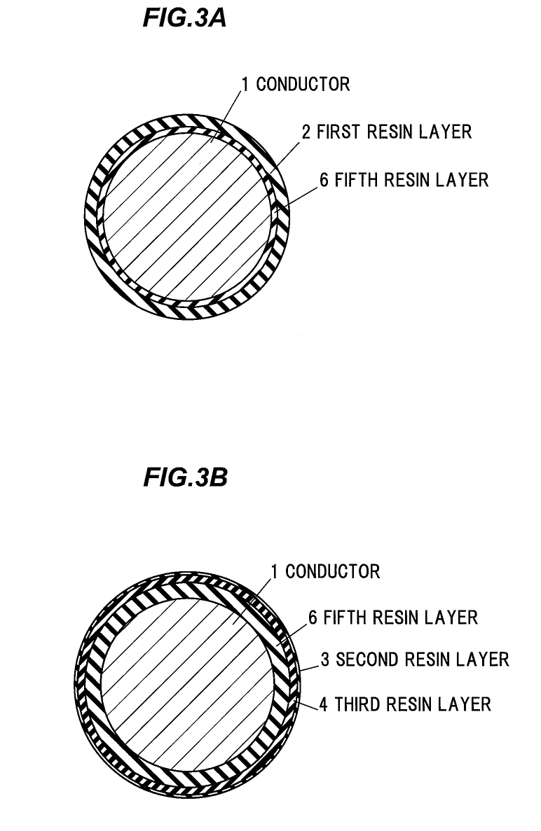

In addition, the first embodiment may be configured such that a fourth resin layer 5 formed of an insulating resin alone or an insulating resin containing, e.g., a lubricant is further provided on the first resin layer 2 as shown in FIG. 2A which is a first modification of the first embodiment, or a fifth resin layer 6 formed of an insulating resin containing, e.g., an adhesive agent is further provided under the first resin layer 2 as shown in FIG. 3A which is a second modification of the first embodiment.

Examples of the conductor 1 used in the first embodiment include, e.g., a copper wire, an aluminum wire, a silver wire and a nickel wire, etc.

The insulating resin used in the first embodiment to constitute the first resin layer 2 is not specifically limited as long as it is industrially used, and examples thereof include, e.g., formal, polyester, polyester-imide, polyamide-imide and polyimide, etc. Note that, the same insulating resin as the first resin layer 2 can be used for forming the second to fifth resin layers 3 to 6.

Examples of the inorganic fine particles used in the first embodiment to constitute the first resin layer 2 (and likewise for the second resin layer 3) include, e.g., metal oxide particles of, e.g., silica, alumina, zirconia, titania and yttria, etc. The material is not specifically limited but silica is preferable from the viewpoint of industrial productivity, cost and low permittivity. The inorganic fine particles may be either hollow or porous inorganic fine particles.

Considering solubility in a resin insulating coating material, the inorganic fine particle used in the first embodiment is preferably organosol (e.g., organo-silica sol) formed by dispersing the above-mentioned inorganic fine particles into a dispersion medium.

In the first embodiment, a resin insulating coating material containing inorganic fine particles is prepared by dissolving, e.g., the above-mentioned insulating resin and the inorganic fine particles into a solvent and is applied and baked on the outer periphery of the conductor 1, thereby obtaining the first resin layer 2.

Examples of the solvent for dissolving the insulating resin include, e.g., γ-butyrolactone, N-methyl-2-pyrrolidone (NMP), N, N-dimethylformamide (DMF), N,N-dimethylacetamide (DMAC), dimethylimidazolidinone (DMI) and cyclic ketones such as cyclohexanone, which can be used alone or in combination of two or more thereof.

A preferred example of the dispersion medium for dispersing the inorganic fine particles in organosol is e.g., a dispersion medium consisting mainly of a cyclic ketone having a boiling point of, e.g., 130° C. to 180° C. (a main dispersion medium). Examples of such a cyclic ketone include, e.g., cycloheptanone (boiling point: 180° C.), cyclohexanone (boiling point: 156° C.) and cyclopentanone (boiling point: 131° C.), etc., which can be used alone or in combination of two or more thereof. In addition, a cyclic ketone of which cyclic structure is partially or completely unsaturated, such as 2-cyclohexen-1-one, may be used.

For the purpose of, e.g., improving stability of the insulated wire varnish formed by mixing organosol with an insulating resin coating material, the dispersion medium may be a mixture of the above-mentioned cyclic ketones with a solvent such as N-methyl-2-pyrrolidone (NMP), N, N-dimethylformamide (DMF) or N,N-dimethylacetamide (DMAC), an aromatic hydrocarbon or a lower alcohol, etc. In this regard, however, it is preferable that a cyclic ketone be not less than 70% of the total dispersion medium contained in the organosol since the higher the ratio of the mixed dispersion solvent other than the cyclic ketone is, the worse the affinity for the insulating resin coating material is.

A particle size of the organosol is preferably not more than 100 nm as an average particle size measured by the BET method in order to effectively exert partial discharge resistance function of the first resin layer 2 (and likewise for the second resin layer 3) and to prevent a decrease in coatability to the conductor 1, and is more preferably not more than 30 nm when considering improvement in transparency of the organosol per se.

The filling amount of the inorganic fine particle is not specifically limited but is preferably within a range of not less than 1 part by mass and not more than 100 parts by mass with respect to 100 parts by mass of the resin content of the insulating resin coating material.

When the third resin layer 4 containing the unreacted organic metal is used in the second embodiment (the third resin layer 4 is equivalent to a layer which is based on the first resin layer 2 of the first embodiment but does not contain the unreacted organic metal), the third resin layer 4 is provided on an inner side (lower side) of the second resin layer 3 which is filled with the inorganic fine particles, as described above. In this case, it is preferable that the unreacted organic metal be contained in the same insulating resin coating material (insulating resin and solvent) as that used for forming the first resin layer 2.

The unreacted organic metal used in the first resin layer 2 or the third resin layer 4 in the first embodiment is preferably formed of one or more selected from the group consisting of metal alkoxide, metal chelate and metal acylate which contain a metal element such as titanium (Ti), aluminum (Al) or zirconium (Zr).

Note that, a reaction rate of the organic metal can be changed by adjusting a molecular weight. For example, for slowing down the reaction rate in order to ensure formation of an inorganic layer, a high-molecular weight organic metal is used. In detail, the metal chelate has a larger molecular weight and thus a slower reaction rate than the metal alkoxide and is therefore preferable. In addition, any of the metal alkoxide, metal chelate and metal acylate can have a slow reaction rate when the molecular weight thereof is high. Furthermore, the unreacted organic metal is preferably encapsulated in a covering material constituting, e.g., a capsule so as to be contained in the form of capsule particles in the first resin layer 2 or the third resin layer 4.

The particle size of the capsule particle is not specifically limited unless causing deterioration in the appearance of the first resin layer 2 or the third resin layer 4 but is preferably, e.g., not more than 10 μm.

Also, the added amount of the capsule particle is not specifically limited unless causing deterioration in the characteristics of the insulated wire but is preferably, e.g., not more than 1/10 of the filling amount of the inorganic fine particle constituting a partial-discharge-resistant layer when expressed in terms of metal oxide obtained by decomposition of the organic metal.

The covering material constituting an outer shell of the capsule particle is preferably formed of a material which is insoluble in a solvent used for the above-mentioned insulating resin coating material and can be eroded and broken by partial discharge at the time of occurrence thereof. In other words, the covering material preferably has a function of protecting the encapsulated organic metal from the insulating resin coating material without being dissolved in the insulating resin coating material when mixed therein and a function of discharging the encapsulated organic metal by being eroded and broken by partial discharge when exposed to the partial discharge.

That is, the functions of the covering material are, e.g., to prevent the organic metal from coming into contact and reacting with the inorganic fine particles, the insulating resin, the solvent or the air etc., in the first resin layer 2 or the third resin layer 4, and to expose the encapsulated organic metal by partial discharge in a state that the inorganic fine particles and the capsule particles are deposited and exposed on the surface of the first resin layer 2 or the third resin layer 4 due to erosion of the first resin layer 2 or the second resin layer 3 containing the inorganic fine particles caused by the partial discharge, such that the reaction of the inorganic fine particles with the organic metal and the resulting formation of the inorganic layer on the first resin layer 2 or the third resin layer 4 are supported.

Preferred examples of a material used for the covering material having such functions include, e.g., solvent-resistant organic materials having a crosslinked chemical structure such as melamine, styrene, acrylic, urethane, polyamide and polyimide. In addition, the outermost shell of the covering material may be coated with a very thin inorganic material such as silica in order to delay erosion time of the covering material due to partial discharge or in order to stabilize the covering material.

FIG. 2A is a cross sectional view showing an insulated wire in the first modification of the first embodiment of the invention and FIG. 2B is a cross sectional view showing an insulated wire in the first modification of the second embodiment of the invention. In addition, FIG. 3A is a cross sectional view showing an insulated wire in the second modification of the first embodiment of the invention and FIG. 3B is a cross sectional view showing an insulated wire in the second modification of the second embodiment of the invention.

The insulated wire shown in FIG. 2A is further provided with the fourth resin layer 5 on the first resin layer 2, and the insulated wire shown in FIG. 3A is further provided with the fifth resin layer 6 under the first resin layer 2.

Meanwhile, the insulated wire shown in FIG. 2B is provided with the fourth resin layer 5 on the second resin layer 3, and the insulated wire shown in FIG. 3B is further provided with the fifth resin layer 6 under the third resin layer 4.

The insulated wires having such structures can also exert the same effects as the insulated wires shown in FIGS. 1A and 1B.

Coil

Coils (not shown) in the present embodiments are formed using the above-mentioned insulated wires. The coils using the above-mentioned insulated wire are not specifically limited and can be manufactured by a general method.

### EXAMPLES

The insulated wire in the invention will be described in more detail below with reference to Examples. It should be noted that the invention should not be construed to be limited by the following Examples.

### Example 1

Organo-silica sol (benzyl alcohol/naphtha system mixed dispersion medium, the average particle size of silica: 12 nm) as inorganic fine particle was dispersed into a tris(2-hydroxyethyl)isocyanurate modified polyester-imide enamel wire varnish as an insulation resin coating material so that the silica content of the organo-silica sol is 20 parts by mass with respect to 100 parts by mass of the resin content of the enamel wire varnish, and an organic metal (trade name: ORGATICS TC-750, manufactured by Matsumoto Fine Chemical Co. Ltd.) in an unreacted state was further mixed thereto, thereby obtaining an insulated wire varnish (a partial-discharge-resistant polyester-imide enamel wire varnish). Then, a first resin layer was formed by applying and baking the obtained varnish on a copper conductor, thereby obtaining an insulation layer having a single layer structure (with an insulation layer having a film thickness of 30 μm).

### Examples 2 and 3

Examples 2 and 3 were same as Example 1, except that the organo-silica sol was dispersed so that the silica content thereof was respectively 5 parts by mass and 100 parts by mass with respect to 100 parts of the resin content.

### Example 4

An organic metal (trade name: ORGATICS TC-750, manufactured by Matsumoto Fine Chemical Co. Ltd.) in an unreacted state was mixed with a tris(2-hydroxyethyl) isocyanurate modified polyester-imide enamel wire varnish as an insulation resin coating material to obtain a varnish. A 20 μm-thick film as a third resin layer was formed by applying and baking the obtained varnish on a copper conductor. Then, a 10 μm-thick film as a second resin layer was formed thereon by applying and baking a partial-discharge-resistant polyester-imide enamel wire varnish which is obtained by dispersing organo-silica sol (benzyl alcohol/naphtha system mixed dispersion medium, the average particle size of silica: 12 nm) as inorganic fine particle into a tris(2-hydroxyethyl) isocyanurate modified polyester-imide enamel wire varnish so that the silica content of the organo-silica sol is 20 parts by mass with respect to 100 parts by mass of the resin content of the enamel wire varnish, thereby obtaining an insulated wire having a two-layer structure (the total film thickness of 30 μm).

### Example 5

Based on Example 4, a film thickness of the second resin layer was changed to 15 μm and a 5 μm-thick film was formed on the second resin layer by applying and baking a general-purpose polyamide-imide enamel wire varnish, thereby obtaining an insulated wire having a three-layer structure (the film thickness of 30 μm).

### Example 6

A 5 μm-thick film as a fifth resin layer was formed on a copper conductor by applying and baking a general-purpose tris(2-hydroxyethyl)isocyanurate modified polyester-imide enamel wire varnish. Then, a 12 μm-thick film as a first resin layer was formed thereon by applying and baking a partial-discharge-resistant polyester-imide enamel wire varnish which is obtained by mixing organo-silica sol (benzyl alcohol/naphtha system mixed dispersion medium, the average particle size of silica: 12 nm) with a tris(2-hydroxyethyl)isocyanurate modified polyester-imide enamel wire varnish so that the silica content of the organo-silica sol is 20 parts by mass with respect to 100 parts by mass of the resin content of the enamel wire varnish and by further mixing an organic metal (trade name: ORGATICS TC-750, manufactured by Matsumoto Fine Chemical Co. Ltd.) in an unreacted state. In addition, a 5 μm-thick film was formed thereon by applying and baking a general-purpose polyamide-imide enamel wire varnish, and furthermore, a 3 μm-thick film as a fourth resin layer was formed thereon by applying and baking a self-lubricating polyamide-imide enamel wire varnish, thereby obtaining an insulated wire having a four-layer structure (the total film thickness of 30 μm).

### Example 7

An organic metal (trade name: ORGATICS TC-750, manufactured by Matsumoto Fine Chemical Co. Ltd.) in an unreacted state was mixed with a polyamide-imide enamel wire varnish to obtain a varnish. A 15 μm-thick film as a third resin layer was formed by applying and baking the obtained varnish on a copper conductor. Then, a 10 μm-thick film as a second resin layer was formed thereon by applying and baking a partial-discharge-resistant polyamide-imide enamel wire varnish which is obtained by dispersing organo-silica sol (cyclohexanone dispersion medium, the average particle size of silica: 23 nm) into a polyamide-imide enamel wire varnish so that the silica content of the organo-silica sol is 20 parts by mass with respect to 100 parts by mass of the resin content of the enamel wire varnish, and furthermore, a 5 μm-thick film as a fourth resin layer was formed thereon by applying and baking a general-purpose polyamide-imide enamel wire varnish, thereby obtaining an insulated wire having a three-layer structure (the total film thickness of 30 μm).

### Example 8

Organo-silica sol (cyclohexanone dispersion medium, the average particle size of silica: 23 nm) was dispersed into a polyamide-imide enamel wire varnish so that the silica content of the organo-silica sol is 20 parts by mass with respect to 100 parts by mass of the resin content of the enamel wire varnish, and an organic metal (trade name: ORGATICS TC-750, manufactured by Matsumoto Fine Chemical Co. Ltd.) in an unreacted state was further mixed thereto, thereby obtaining a partial-discharge-resistant polyamide-imide enamel wire varnish. Then, the partial-discharge-resistant polyamide-imide enamel wire varnish was applied and baked on a copper conductor to form a 25 μm-thick film as a first resin layer, and furthermore, a 5 μm-thick film as a fourth resin layer was formed thereon by applying and baking a general-purpose polyamide-imide enamel wire varnish, thereby obtaining an insulated wire having a two-layer structure (the film thickness of 30 μm).

### Example 9

A 10 μm-thick film as a fifth resin layer was formed on a copper conductor by applying and baking a general-purpose tris(2-hydroxyethyl)isocyanurate modified polyester-imide enamel wire varnish. Then, a 10 μm-thick film as a first resin layer was formed thereon by applying and baking a partial-discharge-resistant polyamide-imide enamel wire varnish which is obtained by dispersing titania fine particles into a polyamide-imide enamel wire varnish (directly dispersing titania particles having an average particle size of 20 nm into the varnish) so that the titania content is 50 parts by mass with respect to 100 parts by mass of the resin content of the enamel wire varnish and by further mixing an organic metal (trade name: ORGATICS TC-750, manufactured by Matsumoto Fine Chemical Co. Ltd.) in an unreacted state, and furthermore, a 10 μm-thick film as a fourth resin layer was formed thereon by applying and baking a general-purpose polyamide-imide enamel wire varnish, thereby obtaining an insulated wire having a three-layer structure (the total film thickness of 30 μm).

### Example 10

A 10 μm-thick film as a fifth resin layer was formed on a copper conductor by applying and baking a general-purpose polyimide enamel wire varnish. Then, a 10 μm-thick film as a first resin layer was formed thereon by applying and baking a partial-discharge-resistant polyimide enamel wire varnish which is obtained by dispersing silica fine particles into a polyimide enamel wire varnish (directly dispersing silica particles having an average particle size of 16 nm into the varnish) so that the silica content is 50 parts by mass with respect to 100 parts by mass of the resin content of the enamel wire varnish and by further mixing an organic metal (trade name: ORGATICS TC-750, manufactured by Matsumoto Fine Chemical Co. Ltd.) in an unreacted state, and furthermore, a 10 μm-thick film as a fourth resin layer was formed thereon by applying and baking a general-purpose polyimide enamel wire varnish, thereby obtaining an insulated wire having a three-layer structure (the total film thickness of 30 μm).

### Comparative Example 1

Organo-silica sol (benzyl alcohol/naphtha system mixed dispersion medium, the average particle size of silica: 12 nm) was dispersed into a tris(2-hydroxyethyl) isocyanurate modified polyester-imide enamel wire varnish so that the silica content of the organo-silica sol is 20 parts by mass with respect to 100 parts by mass of the resin content of the enamel wire varnish, thereby obtaining a partial-discharge-resistant polyester-imide enamel wire varnish. Then, a layer corresponding to the second resin layer was formed by applying and baking the obtained varnish on a copper conductor, thereby obtaining an insulation layer having a single layer structure (the film thickness of 30 μm).

### Comparative Example 2

A 20 μm-thick film corresponding to the fifth resin layer was formed by applying and baking a general-purpose tris(2-hydroxyethyl)isocyanurate modified polyester-imide enamel wire varnish on a copper conductor. Then, a 10 μm-thick film corresponding to the second resin layer was formed thereon by applying and baking a partial-discharge-resistant polyester-imide enamel wire varnish which is obtained by dispersing organo-silica sol (benzyl alcohol/naphtha system mixed dispersion medium, the average particle size of silica: 12 nm) into a tris(2-hydroxyethyl)isocyanurate modified polyester-imide enamel wire varnish so that the silica content of the organo-silica sol is 20 parts by mass with respect to 100 parts by mass of the resin content of the enamel wire varnish, thereby obtaining an insulated wire having a two-layer structure (the total film thickness of 30 μm).

### Comparative Example 3

A 10 μm-thick film corresponding to the fifth resin layer was formed by applying and baking a general-purpose tris(2-hydroxyethyl)isocyanurate modified polyester-imide enamel wire varnish on a copper conductor. Then, a 10 μm-thick film corresponding to the second resin layer was formed thereon by applying and baking a partial-discharge-resistant polyamide-imide enamel wire varnish which is obtained by dispersing titania fine particles into a polyamide-imide enamel wire varnish (directly dispersing titania particles having an average particle size of 20 nm into the varnish) so that the titania content is 50 parts by mass with respect to 100 parts by mass of the resin content of the enamel wire varnish, and furthermore, a 10 μm-thick film corresponding to the fourth resin layer was formed thereon by applying and baking a general-purpose polyamide-imide enamel wire varnish, thereby obtaining an insulated wire having a three-layer structure (the total film thickness of 30 μm).

### Comparative Example 4

A 15 μm-thick film corresponding to the fifth resin layer was formed by applying and baking a general-purpose polyamide-imide enamel wire varnish. Then, a 12 μm-thick film corresponding to the second resin layer was formed thereon by applying and baking a partial-discharge-resistant polyamide-imide enamel wire varnish which is obtained by dispersing organo-silica sol (cyclohexanone dispersion medium, the average particle size of silica: 23 nm) into a polyamide-imide enamel wire varnish so that the silica content of the organo-silica sol is 20 parts by mass with respect to 100 parts by mass of the resin content of the enamel wire varnish. In addition, a 5 μm-thick film corresponding to the third resin layer was formed thereon by applying and baking a varnish obtained by mixing an organic metal (trade name: ORGATICS TC-750, manufactured by Matsumoto Fine Chemical Co. Ltd.) in an unreacted state with a general purpose polyamide-imide enamel wire varnish, and furthermore, a 3 μm-thick film as a fourth resin layer was formed thereon by applying and baking a self-lubricating polyamide-imide enamel wire varnish, thereby obtaining an insulated wire having a four-layer structure (the total film thickness of 35 μm).

### Comparative Example 5

A layer corresponding to the fifth resin layer was formed using a polyamide-imide enamel wire varnish, thereby obtaining a polyamide-imide enamel wire having a conductor diameter of 0.8 mm (the film thickness of 30 μm).

Table 1 shows materials and structures used in Examples 1 to 10 and Comparative Examples 1 to 5 as well as characteristics of the obtained insulated wires (enamel wires).

TABLE 1

| | | | | Ex 1 | Ex 2 | Ex 3 | Ex 4 | Ex 5 | Ex 6 | Ex 7 | Ex 8 | Ex 9 | Ex 10 | CE 1 | CE 2 | CE 3 | CE 4 | CE 5 |
|---|---|---|---|---|---|---|---|---|---|---|---|---|---|---|---|---|---|---|
| Materials and | First layer | Film thickness | | 30 | 30 | 30 | 20 | 15 | 5 | 15 | 25 | 10 | 10 | 30 | 20 | 10 | 15 | 30 |
| structure of | | Resin | TMP resin | 100 | 100 | 100 | 100 | 100 | 100 | | | 100 | | 100 | 100 | 100 | | |
| insulated wires | | | Polyamide-imide | | | | | | | 100 | 100 | | | | | | 100 | 100 |
| | | | resin | | | | | | | | | | | | | | | |
| | | | Polyimide resin | | | | | | | | | | 100 | | | | | |

| Organic metals | | | Inc | Inc | Inc | Inc | Inc | Not | Inc | Inc | Not | Not | Not | Not | Not | Not | Not |
|---|---|---|---|---|---|---|---|---|---|---|---|---|---|---|---|---|---|
| Inorganic | Silica sol | BDM | 20 | 5 | 100 | | | | | | | | 20 | | | | |
| fine particle | | APS: 12 nm | | | | | | | | | | | | | | | |
| | | CDM | | | | | | | | 20 | | | | | | | |
| | | APS: 23 nm | | | | | | | | | | | | | | | |
| | Ti FP | APS: 20 nm | | | | | | | | | | | | | | | |
| | Si FP | APS: 16 nm | | | | | | | | | | | | | | | |

| Second | Film thickness | | 10 | 10 | 12 | 10 | 5 | 10 | 10 | 10 | 10 | 12 |
|---|---|---|---|---|---|---|---|---|---|---|---|---|
| Layer | Resin | TMP resin | 100 | 100 | 100 | | | | | 100 | | |
| | | Polyamide-imide resin | | | | 100 | 100 | 100 | | | 100 | 100 |
| | | Polyimide resin | | | | | | | 100 | | | |

| Organic metals | | | Not | Not | Not | Not | Not | Inc | Not | Not | Inc | Inc | Not | Not | Not | Not | Not |
|---|---|---|---|---|---|---|---|---|---|---|---|---|---|---|---|---|---|
| Inorganic | Silica sol | BDM | | | | 20 | 20 | 20 | | | | | | 20 | | | |
| fine particle | | APS: 12 nm | | | | | | | | | | | | | | | |
| | | CDM | | | | | | | 20 | | | | | | | 20 | |
| | | APS: 23 nm | | | | | | | | | | | | | | | |
| | Ti FP | APS: 20 nm | | | | | | | | | 50 | | | | 50 | | |
| | Si FP | APS: 16 nm | | | | | | | | | | 50 | | | | | |

| Third | Film thickness | | 5 | 5 | 5 | 10 | 10 | 10 | 5 |
|---|---|---|---|---|---|---|---|---|---|
| Layer | Resin | TMP resin | | | | | | | |
| | | Polyamide-imide resin | 100 | 100 | 100 | 100 | 100 | 100 | 100 |
| | | Polyimide resin | | | | | | | |

| | | | | | | | | | | | | | | | |
|---|---|---|---|---|---|---|---|---|---|---|---|---|---|---|---|
| Organic metals | Not | Not | Not | Not | Not | Not | Not | Not | Not | Not | Not | Not | Not | Inc | Not |

| Fourth | Film thickness | | 3 | 3 |
|---|---|---|---|---|
| layer | Resin | Self-lubricating | 100 | 100 |
| | | polyamide-imide resin | | |

| | | | | | | | | | | | | | | | | | |
|---|---|---|---|---|---|---|---|---|---|---|---|---|---|---|---|---|---|
| Characteristics of | Dimension | Conductor diameter | 0.800 | 0.800 | 0.801 | 0.800 | 0.800 | 0.800 | 0.800 | 0.800 | 0.800 | 0.800 | 0.799 | 0.800 | 0.800 | 0.800 | 0.800 |
| Insulated wires | | Film thickness | 0.030 | 0.030 | 0.031 | 0.030 | 0.030 | 0.030 | 0.030 | 0.030 | 0.030 | 0.030 | 0.030 | 0.030 | 0.031 | 0.030 | 0.030 |
| | | Overall diameter | 0.860 | 0.860 | 0.862 | 0.860 | 0.860 | 0.860 | 0.860 | 0.860 | 0.860 | 0.860 | 0.859 | 0.860 | 0.863 | 0.860 | 0.860 |

| Flexibility: Acceptable winding | | 1d | 1d | 1d | 1d | 1d | 1d | 1d | 1d | 1d | 1d | 1d | 1d | 1d | 1d | 1d |
|---|---|---|---|---|---|---|---|---|---|---|---|---|---|---|---|---|
| diameter | | | | | | | | | | | | | | | | |
| Breakdown voltage (kV) | | 14.6 | 14.7 | 14.0 | 15.0 | 14.3 | 14.3 | 14.2 | 14.0 | 12.6 | 12.1 | 14.3 | 14.6 | 12.0 | 14.3 | 14.5 |
| V-t characteristics (h) | Original state | 3K< | 3K< | 3K< | 3K< | 3K< | 3K< | 3K< | 3K< | 3K< | 3K< | 380.5 | 153.6 | 130.0 | 158.9 | 0.70 |
| sine wave of 10 kHz - 1.4 kV | Elongation of | 3K< | 3K< | 3K< | 3K< | 3K< | 3K< | 3K< | 3K< | 392.0 | 387.0 | 335.0 | 136.3 | 12.8 | 145.2 | 0.65 |
| | 20% | | | | | | | | | | | | | | | |

Ex: Example,
CE: Comparative Example,
Inc: included,
Not: not included,
TMP resin: THEIC modified polyester-imide resin,
BDM: Benzyl alcohol/naphtha system mixed dispersion medium,
CDM: Cyclohexanone system dispersion medium,
APS: Average Particle Size,
Ti FP: Titania fine particle,
Si FP: Silica fine particle,
3K: 3000

Flexibility and insulation breakdown tests were conducted on the insulated wires in accordance with JIS C 3003. For partial discharge resistance, a non-elongated twisted-pair enamel wire test piece and a 20%-elongated twisted-pair enamel wire test piece were made by a method in accordance with JIS C 3216, using two non-elongated enamel wires and two 20%-elongated enamel wires. Electricity was applied to the enamel wire test pieces under the condition of a frequency of 10 kHz and voltage of 1.4 kV (sine wave). Then, evaluation was conducted based on the V-t characteristic test (voltage-partial discharge lifetime characteristics test) in the non-elongated state and that after 20% elongation. Note that, tris(2-hydroxyethyl)isocyanurate is abbreviated and described as THEIC in Table 1.

As understood from Table 1, very good V-t characteristics of more than 3000 h, especially in the non-elongated state, were exhibited in both the case where the unreacted organic metal is contained in the first resin layer and the case where the unreacted organic metal is contained in the third resin layer.

The reason is considered as follows: in the V-t characteristic test, the inorganic fine particles is deposited on a surface after occurrence of erosion of the film due to partial discharge and form a layer and, simultaneously or little belatedly, the unreacted organic metal is exposed by erosion or breakage, etc., and is then discharged. The organic content bound in the organic metal is lost due to, e.g., chain scission caused by partial discharge, chain scission caused by local heating or hydrolysis by moisture in the air and the organic metal per se thus becomes a highly active state and serves to bind the inorganic fine particles deposited on the surface, resulting in that the inorganic fine particle layer becomes more rigid. As a result, partial discharge erosion is suppressed, thereby contributing to life extension.

In the insulated wires in Comparative Examples 1 to 3 using a general-purpose material without containing an unreacted organic metal, a life extension effect was exerted but was only about several hundred times longer than a general-purpose enamel wire in Comparative Example 5. In Comparative Example 4 in which a layer corresponding to the third resin layer containing the unreacted organic metal is located on an outer side (upper side) of the second resin layer, the life extension effect was not observed, neither. It is considered that this is because the organic metal activated by partial discharge does not contribute to reinforcement of the inorganic layer without presence of the inorganic fine particles therearound and loses activity.

Although the invention has been described with respect to the specific embodiments for complete and clear disclosure, the appended claims are not to be therefore limited but are to be construed as embodying all modifications and alternative constructions that may occur to one skilled in the art which fairly fall within the basic teaching herein set forth.

What is claimed is:

1. An insulated wire, comprising:
a conductor; and
a first resin layer formed on an outer periphery of the conductor,
wherein the first resin layer comprises an insulating resin comprising inorganic fine particles and an unreacted organic metal.

2. An insulated wire, comprising:
a conductor;
a second resin layer formed on an outer periphery of the conductor and comprising an insulating resin that contains inorganic fine particles; and
a third resin layer formed under the second resin layer and comprising an unreacted organic metal.

3. The insulated wire according to claim 1, wherein the organic metal comprises one of metal alkoxide, metal chelate and metal acylate.

4. The insulated wire according to claim 1, wherein the organic metal is included in a state of being encapsulated in a covering material constituting a capsule.

5. The insulated wire according to claim 1, wherein the inorganic fine particle comprises organo-silica sol.

6. The insulated wire according to claim 1, further comprising:
an inorganic layer formed on the first or third resin layer by reaction between the organic metal and the inorganic fine particles, the organic metal and the inorganic fine particles being deposited on a surface of the first or third resin layer due to partial discharge.

7. The insulated wire according to claim 2, wherein the organic metal comprises one of metal alkoxide, metal chelate and metal acylate.

8. The insulated wire according to claim 2, wherein the organic metal is included in a state of being encapsulated in a covering material constituting a capsule.

9. The insulated wire according to claim 2, wherein the inorganic fine particle comprises organo-silica sol.

10. The insulated wire according to claim 2, further comprising an inorganic layer formed on the first or third resin layer by reaction between the organic metal and the inorganic fine particles, the organic metal and the inorganic fine particles being deposited on a surface of the first or third resin layer due to partial discharge.

11. The insulated wire according to claim 1, further comprising a fourth resin layer under the first resin layer or a fifth resin layer on the first resin layer.

12. The insulated wire according to claim 2, further comprising a fourth resin layer under the second resin layer or a fifth resin layer on the third resin layer.

13. A coil, comprising:
the insulated wire according to claim 1.

14. A coil, comprising:
the insulated wire according to claim 2.
